(19) United States
(12) Patent Application Publication
(10) Pub. No.: US 2004/0207517 A1
(43) Pub. Date: Oct. 21, 2004

(54) Dump truck tailgate latch monitor

(76) Inventor: Floyd Cole, Norfolk, VA (US)

Correspondence Address: BRADLEY D. GOLDIZEN, 505 SOUTH INDEPENDENCE BOULEVARD, SUITE 102, VIRGINIA BEACH, VA, 23452, US

(21) Appl. No.: 10/839,917

(22) Filed: May 6, 2004

Related U.S. Application Data
(63) Continuation-in-part of application No. 09/978,245, filed on Oct. 17, 2001, now Pat. No. 6,753,787.

(51) Int. Cl. B60Q 1/00

(52) U.S. Cl. 340/438

(57) ABSTRACT

The present invention includes a device for alerting the operator of a truck equipped with a dump bed when the tailgate is unsecured. In one embodiment, the device is connected to an existing “low air” alarm that indicates a rapid drop in air pressure in the air hoses of the brakes. Thus, when the tailgate is unsecured, air pressure in the air hoses drops and a warning indicator alerts the operator of the existence of a dangerous condition. The alarm is deactivated by properly securing the tailgate. In another embodiment, an electrical switch connected to the mechanism that secures the tailgate. An alarm signal is provided to the operator when the mechanism is not properly securing the tailgate. The invention also includes a method for bleeding air from the air system that operates brakes of a dump truck to cause the “low air” alarm to be actuated.

The present application is a continuation-in-part application of U.S. patent Ser. No. 09/978,245 filed on Oct. 17, 2001.

This invention did not receive and federal research/development funding.

### BACKGROUND OF THE INVENTION

Throughout this application, the term “dump truck” is used. This term is to be interpreted broadly and incorporates both dump trucks and dump trailers.

This invention relates to an alarm system for alerting an operator of a dump truck, when the tailgate has been left unsecured. Unlike other types of automobiles such as pickups, dump trucks have tailgates that pivot about an axis located at the top of the tailgate. When an operator desires to dump a load from the bed of his truck, he must raise the front of the bed. As the front of the bed is raised, the load slides rearward and pushes against the tailgate. The weight of the load causes the bottom of the tailgate to be pushed outward and the load then slides from the bed. Most modern dump trucks are equipped with a secured load latch that must be actuated by the operator of the dump truck to secure the tailgate. In many dump trucks the operator must release the safety device prior to raising the bed of the truck to dump a load.

Dump trucks are used for a variety of hauling tasks in today's society. Roadway and building construction sites require vast amounts of fill materials such as sand, gravel or stone. These fill materials are typically hauled in the beds of dump trucks. Additionally, large chunks of rubble from building demolition sites are hauled to land fills in dump trucks. Dump truck loads can shift in the bed during transport and be inadvertently deposited on a roadway surface if the tailgate is not safely latched. Other roadway hazards may be created when debris from an unsecured dump truck falls onto a roadway. For example, gravel from the dump bed of a dump truck, having an unsecured tailgate, may fall onto a road surface and damage an automobile following the vehicle. Gravel falling from dump truck beds typically damages automobiles following the dump truck by breaking headlights and windshields, damaging radiators or chipping paint. Moreover, an operator of a vehicle may be startled if his windshield is suddenly shattered and wreck the automobile.

Most modern dump trucks are equipped with a latch that secures the tailgate and prevents it from inadvertently opening. However, the latch cannot prevent the tailgate from opening if the operator has not properly latched it. Also operators forget to lock the tailgate between filling the bed and dumping the loads. For example, some dump trucks haul 10 to 12 loads a day or 200 to 260 tons of material a day. Thus, a portion of the load may fall out of the bed and onto the roadway surface thereby creating a roadway hazard. Individuals in automobiles following the dump truck may be hit by a portion of the load that has fallen from the bed of the truck as mentioned above. Alternatively, it may become necessary for the individuals to deviate from their intended course of travel and thereby cause an accident.

U.S. Pat. No. 6,137,419 to Lennox et al. discloses a pickup truck tailgate monitor. In Lennox, a tailgate monitor in an operator's compartment of a pickup warns the operator if the tailgate is open. A tailgate for a pickup tends to swing to an open position when the tailgate is not secured. Thus, Lennox uses a sensor mounted on the bed to indicate when the tailgate is open. However, the Lennox device cannot be properly used on a dump truck since the tailgate of a dump truck tends to be closed except when the bed is raised.

U.S. Pat. No. 3,789,357 to Fritz, Jr. discloses a safety apparatus for dump trucks. In Fritz, Jr., a safety circuit automatically shuts off the engine of the dump truck when the bed is raised while the tailgate is closed. Another circuit provides a lamp that indicates when the tailgate is opened. However, Fritz, Jr. requires that the bed be raised in order for the tailgate to open. Thus, a load may be deposited in the bed of a dump truck equipped with the Fritz, Jr. device and the lamp may not be lit until a portion of the load has been inadvertently dumped onto a roadway surface.

Neither of these devices can prevent the existence of a dangerous condition such as when the tailgate is in an unsecured closed position. If a dump truck is equipped with either the Lennox or the Fritz, Jr. device, the tailgate may be closed but not secure. Thus, neither Lennox nor Fritz, Jr. contemplates the problem to be solved by the present invention.

### BRIEF SUMMARY OF THE INVENTION

The present invention includes a retro-fit kit that may be installed on existing dump trucks to alert an operator of the existence of a dangerous condition. Typically, trucks with dump beds are equipped with braking systems that operate by utilizing air pressure. An air source such as a compressor generates an air pressure that is stored in a bladder or air tank. The air pressure acts in essentially the same manner as fluid in a passenger car's brake system. As the operator of the dump truck depresses the brake pedal, the air pressure causes the brake shoes to contact with rotating parts of the wheels (rotor).

Since air pressure is a necessary component for actuating the brake system of the dump truck, it must be constantly monitored. Many dump trucks are equipped with an audible alarm that emits a sound when the air pressure in the brake system falls below a set threshold. If the air pressure falls below a second threshold or becomes nil, the brake system of the dump truck will “lock up.” Thus, the dump truck will not move when the air pressure falls below the second threshold. When the “low air” pressure alarm sounds, the dump truck operator must identify the source of the problem or else risk the possibility of losing control of the dump truck.

Many modem dump trucks are equipped with a safety mechanism comprising a safety catch that secures the tailgate on a dump truck. Typically, the safety catch is actuated with pneumatic piston that operates by air pressure. The air pressure may be either positive or negative depending upon the configuration of the system. Likewise, hydraulic systems may be used to actuate the safety catch. For ease of understanding, the positive air pressure is only discussed herein.

The pneumatic piston comprises an air chamber and a piston arm. As air is forced into one end of the air chamber, the piston arm is extended from the piston. If air is forced into an opposite end of the air chamber, the piston arm is retracted into the piston. A linkage is connected to the piston arm for transferring the movement of the piston arm to cause the safety catch to be engaged and disengaged. Using this system, an operator of a dump truck can disengage the safety catch and raise the dump bed to dump a load without leaving the cab of the dump truck.

In a typical arrangement, the piston receives air from either of two air supply hoses. The first air supply hose is connected to the piston on an end opposite the second air supply hose. When an air source supplies a positive air pressure through the first hose, the piston arm is extended from the piston. This causes the safety catch to be released. When the air source supplies a positive air pressure through the second hose, the piston arm is retracted into the piston. If the dump bed is down the tailgate is closed and the safety catch will be activated as the piston arm is retracted into the piston.

It should be noted that the pneumatic piston might be substituted for a hydraulic one that operates similar to the pneumatic piston explained above. Alternatively, the pneumatic piston may be biased in one direction of operation, i.e. extended or retracted, and operated by an air pressure in the opposite direction.

In one embodiment of the invention, the “low air” warning indicator is used to alert the dump truck operator that the tailgate is not secured.

In another embodiment, an electrical circuit is provided that alerts the dump truck operator of the dangerous condition. In this embodiment, an indicator means, such as a lamp or buzzer, is located in the operator's cab of the truck. A switch is located near the piston arm and is connected on one side (contact) to the lamp or buzzer and on the other side (contact) to a voltage source. The switch is connected via conductors such as stranded wire that may be wrapped around or ran through the frame of the truck. The voltage source may be either an independent voltage source or a source supplied from the truck's electrical system.

The safety system indicates when a safety device or latch for securing a tailgate is engaged. The safety system includes a piston for actuating the safety device and a linkage connected between the piston and the safety device. The safety system further includes an electrical circuit that comprises an indicator device that indicates a position of the safety device. An electrical power source supplies power to the indicator device. A switch indicates whether the safety device for securing the tailgate is disengaged. The switch is closed when the safety device is disengaged to allow electrical power from the electrical power source to flow through the indicator device. The safety system may include an indicator device that is a lamp which is lit when the safety device is disengaged. Alternatively, the indicator device includes a speaker that emits sound when the safety device is disengaged.

The switch is biased towards a closed position by the piston when the safety device is disengaged and towards an open position when the safety device is engaged. Otherwise, the switch is biased towards a closed position by the linkage when the safety device is disengaged and towards an open position when the safety device is engaged. Alternatively, the switch is biased towards a closed position by the safety device when the safety device is disengaged and towards an open position when the safety device is engaged. The electrical power source is battery system of an automobile.

The invention includes an electrical circuit for indicating whether a safety device that secures a tailgate is engaged. The electrical circuit comprises an indicator device that indicates a position of the safety device. An electrical power source for supplies power to the indicator device. A switch indicates whether the safety device for securing the tailgate is disengaged. The switch is closed when the safety device is disengaged to allow electrical power from the electrical power source to flow through the indicator device. The indicator device may be a lamp that is lit when the safety device is disengaged. Otherwise, the indicator device includes a buzzer or speaker that emits sound when the safety device is disengaged. The switch is biased towards a closed position by the piston when the safety device is disengaged and towards an open position when the safety device is engaged. Alternatively, the switch is biased towards a closed position by the linkage when the safety device is disengaged and towards an open position when the safety device is engaged. Otherwise, the switch is biased towards a closed position by the safety device when the safety device is disengaged and towards an open position when the safety device is engaged. The electrical power source is battery system of an automobile.

The warning system that indicates whether a tailgate is unsecured comprises a lamp for indicating when a latch that secures a tailgate is disengaged. A power source provides electrical energy to the lamp. A switch energizes the lamp when the latch is disengaged.

In one embodiment, the switch is actuated by movement of either the piston, linkage or the safety catch to close the circuit and connect the voltage source to the indicator means. The switch may be a normally closed plunger type that is biased in an open position when the latch engages the lug. Thus, the switch may be mounted in a manner such that either the piston, linkage or safety catch biases the switch open when the safety catch engages the lug on the tailgate. The indicator means is inoperable when the switch is open which corresponds to when the safety catch engages the lug. When the safety catch is disengaged from the lug, such that the tailgate may open, the biasing force keeping the switch open is removed. The switch then closes to alert the operator. Thus, the plunger closes the circuit to connect the indicator means to the voltage source to alert the operator that the tailgate is unsecured.

In a further embodiment, a magnetically actuated reed switch is closed to activate the indicator means when a magnet mounted on one of the piston, linkage or safety catch passes near the reed switch. Thus, a small magnet may be mounted to come close to the reed switch to pull the switch closed when the safety catch is disengaged. When the safety catch is engaged, the magnet is moved away from the reed switch allowing the reed switch to open.

It is an object of the invention to provide an alarm that alerts an operator of a dump truck when the tailgate is left unsecured. Operators often forget to lock tail gate prior to dumping their last load.

It is another object of the invention to provide a method for modifying the existing “low air” alarm in a dump truck to alert an operator when the tailgate has been left unsecured by running a T-fitting off a line to the same alarm.

It is a further object of the invention to provide an electrically operated alarm for alerting the operator when the tailgate is unsecured.

### BRIEF DESCRIPTION OF THE DRAWINGS

FIG. 1 depicts a dump truck.

FIG. 2 depicts a tailgate of a dump truck equipped with a safety catch.

FIG. 3A depicts a side view of a dump truck having the safety catch engaged.

FIG. 3B depicts a side view of a dump truck having the bed raised and the safety catch disengaged.

FIG. 4 depicts an air piston that operates a safety catch on a dump truck in the open position.

FIG. 5 depicts an operator mechanism for operating the air piston of FIG. 4.

FIG. 6 depicts a schematic for an electrically operated safety alarm.

FIG. 7A is a partial view of the first electrical embodiment using a plunger type switch for actuating an indicator means with the safety catch engaged.

FIG. 7B is a partial view of the first electrical embodiment using a plunger type switch with the safety catch disengaged.

FIG. 8A is a schematic view of a second electrical embodiment using a magnetic reed switch for actuating the indicator means and corresponding to an engaged safety catch.

FIG. 8B is a schematic view of the second electrical embodiment using a magnetic reed switch for actuating the indicator means corresponding and to a disengaged safety catch.

### DETAILED DESCRIPTION OF THE INVENTION

The following is the preferred embodiment or best mode for carrying out the invention. It should be noted that this invention is not limited by the discussion of the preferred embodiment.

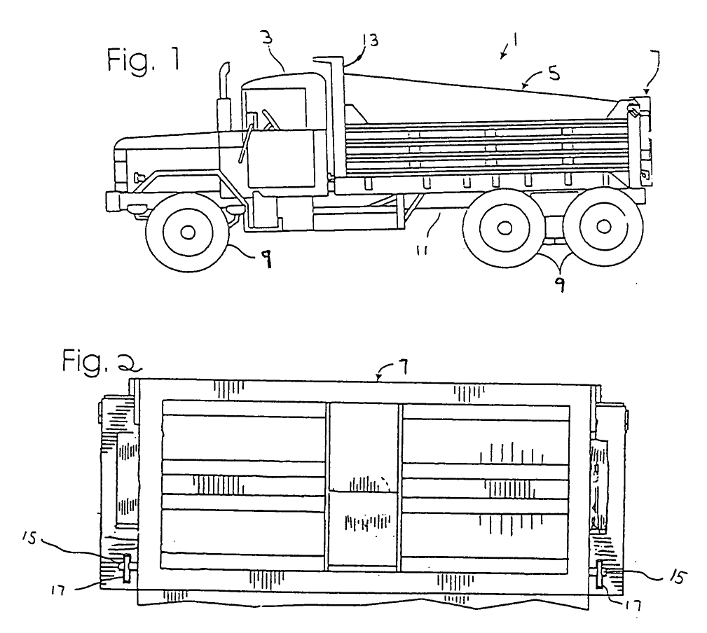

FIG. 1 shows a dump truck 1. Dump truck 1 comprises an operator compartment 3 (cab) and a bed 5. Bed 5 is pivotally mounted on frame 11 that is mounted on wheels 9. Bed 5 includes a floor (not shown) and a front wall 13 that is adjacent cab 3. A pair of laterally spaced sidewalls extend rearward from front wall 13 to define a rear opening. Dump truck 1 further includes a tailgate 7 that is pivotally mounted on the upper portion of each sidewall. A hydraulic lift system (not shown) is mounted on frame 11 for selectively causing the front portion of bed 5 to be raised at an angle with respect to frame 11, thereby causing bed 5 to be inclined downwardly as it extends toward the rear opening.

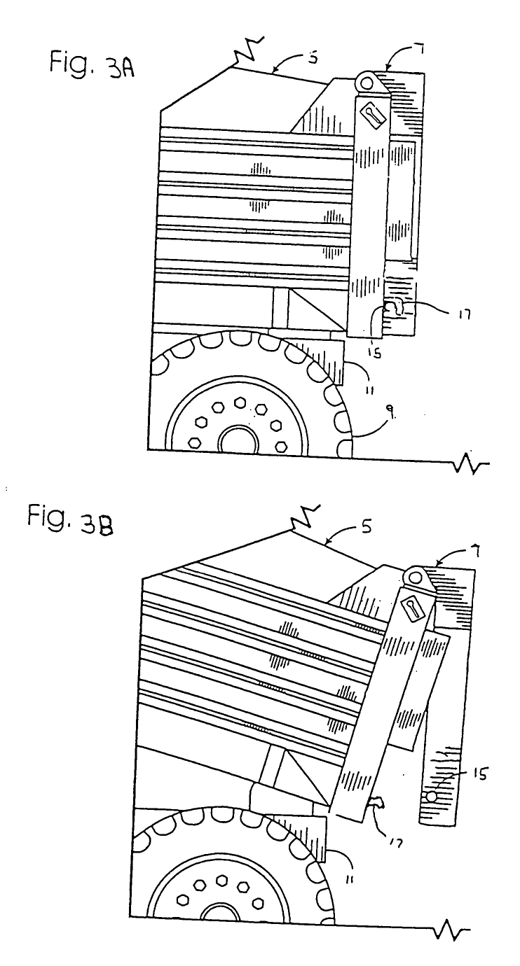

FIG. 2 shows tailgate 7. The pivot mechanism for tailgate 7 has not been shown for ease in understanding the invention. Lugs 15 extend from a lower portion of tailgate 7. Catch 17 engages lug 15 on either side of tailgate 7. When catch 17 is properly engaging lug 15, tailgate 7 is secured and thereby prevented from inadvertently opening.

FIG. 3A shows a side view of tailgate 7 in a closed and secured state. Bed 5 is shown in a lowered state and resting upon frame 11. Lug 15 is engaged by catch 17, thereby preventing tailgate 7 from opening. FIG. 3B depicts bed 5 in a raised state. Catch 17 has been disengaged from lug 15, thereby allowing the bottom portion of tailgate 7 to rotate outward away from the floor of bed 5. FIG. 3B exemplifies dump truck 1 when a load is being dumped from bed 5.

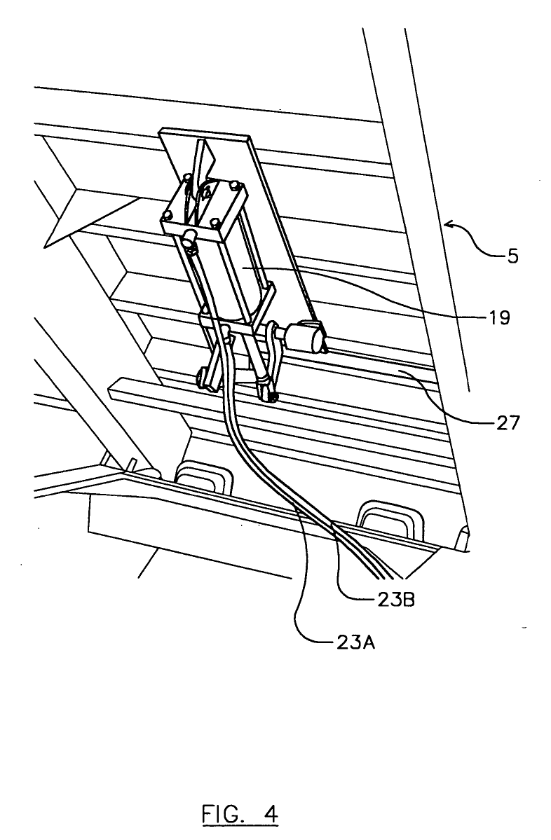

In FIG. 4, bed 5 is in a raised position for ease in understanding the invention. Ordinarily, catch 17 is disengaged from lug 15 before raising bed 5. Piston 19 is affixed to the underside of bed 5. Two air hoses 23A and 23B connect to piston 19, one at each end. Linkage 27 connects at one end to piston arm 21 and at the other end to catch 17. Air hose 23A, connected to piston 19 at the end opposite piston arm 21, is used to supply air into piston 19 to force piston arm 21 to be extended as shown in FIG. 4. The other air hose 23B, is used to retract piston arm 21 into piston 19.

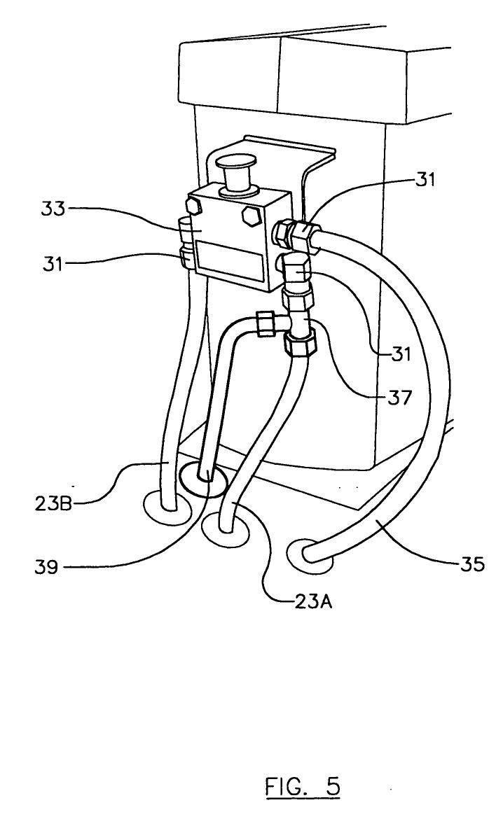

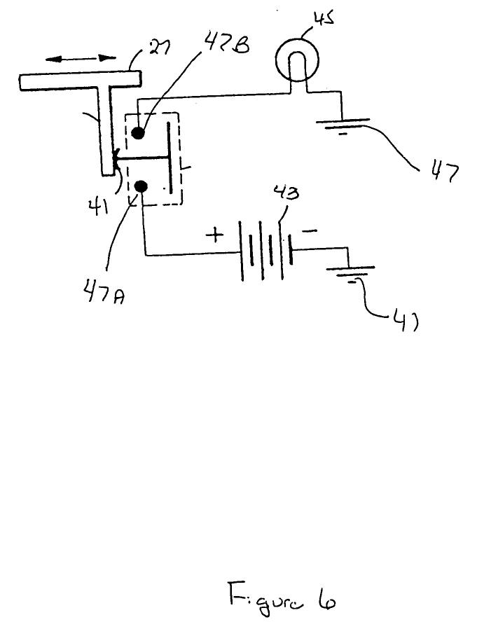

FIG. 5 shows an operator mechanism 29 for operating the air piston of FIG. 4. Operator mechanism 29 comprises air valve 33 for controlling the flow of air into air hoses 23A and 23B. Brass fittings 31 connect the air hoses 23A and 23B to air valve 33. Air supply hose 35 supplies an air source to either hose 23A or 23B. Air hose 23A includes t-shaped connector 37 for bleeding air from hose 23A. When an operator disengages catch 17 from lug 15, air is constantly bled from t-shaped connector 37 through hose 39. This causes the low air warning buzzer to be actuated while catch 17 is disengaged from lug 15. When the operator changes the position of air valve 33 to force air into hose 23B, catch 17 engages lug 15 and the low air warning buzzer automatically shuts off as the air pressure increases above a threshold level. It should be noted that t-shaped connector 37 may be positioned anywhere on hose 23A such that it bleeds air from the air system when catch 17 is disengaged from lug 15.

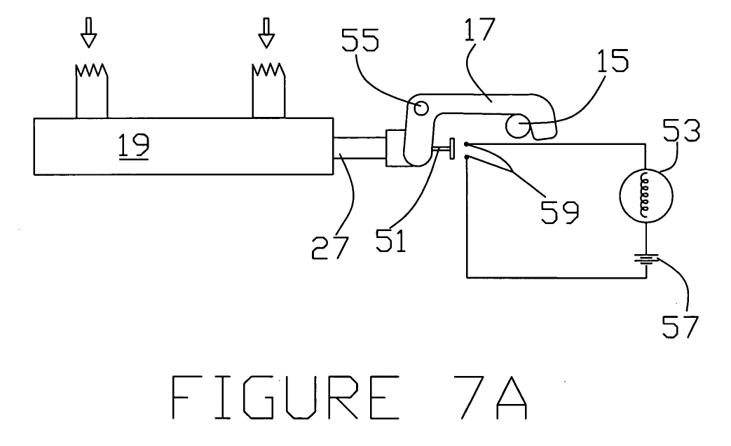

FIG. 6 depicts an electrical embodiment of the invention. Switch 41 is closed by linkage 27 when catch 17 is disengaged from lug 15. Lamp 45 is located in cab 3 and lit when catch 17 is disengaged from lug 15. Voltage source 43 connects to contact 47A. Lamp 45 connects to contact 47B. When catch 17 engages lug 15, linkage 27 causes switch 41 to close contacts 47A and 47B. An electrical path is created between voltage source 43 and ground 47, thereby allowing current to flow between the two. Lamp 45 becomes lit. It should be noted that various other arrangements of electrical components might be configured to implement this embodiment. Thus, this embodiment of the invention is not limited by this method of implementing the invention.

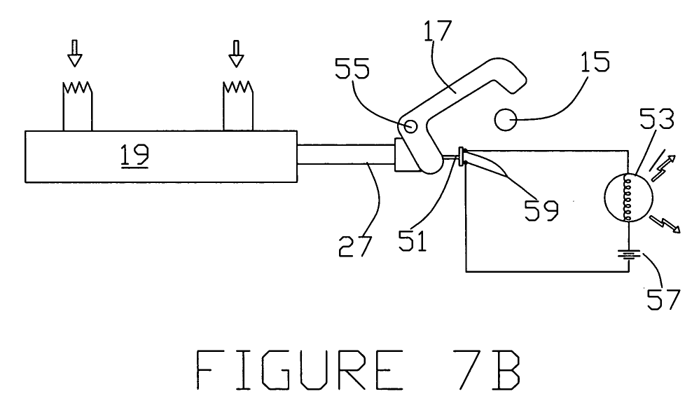

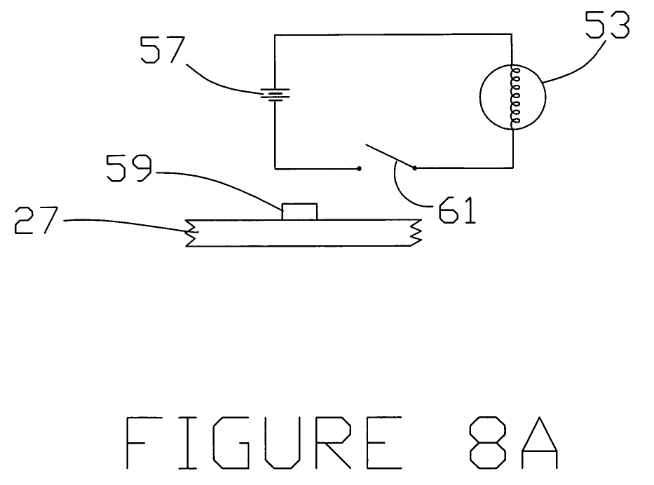

Now referring to FIGS. 7A and 7B, wherein the electrical circuit shown in FIG. 6 is shown implemented with a plunger switch 51 is shown. The plunger switch is open when the catch 17 engages lug 15. Thus, no electrical current flows through indicator device 53 as shown in FIG. 7A. FIG. 7B shows the plunger switch biased in a closed position when the latch 17 disengages lug 15. In this instance, the linkage 27 is extended from piston 19 causing latch 17 to rotate about a pivot point 55. Plunger switch 51 closes contacts 59 by the rotation of catch 17 allowing electrical energy to flow from voltage source 57 through indicator device 53. It should be noted that the plunger switch 51 may also be arranged along the piston 19 or linkage 27. The indicator device 53 depicts a lamp as being as the indicator device. However, it should be understood that the indicator device could be a buzzer or speaker for audibly indicating when the catch 17 engages lug 15.

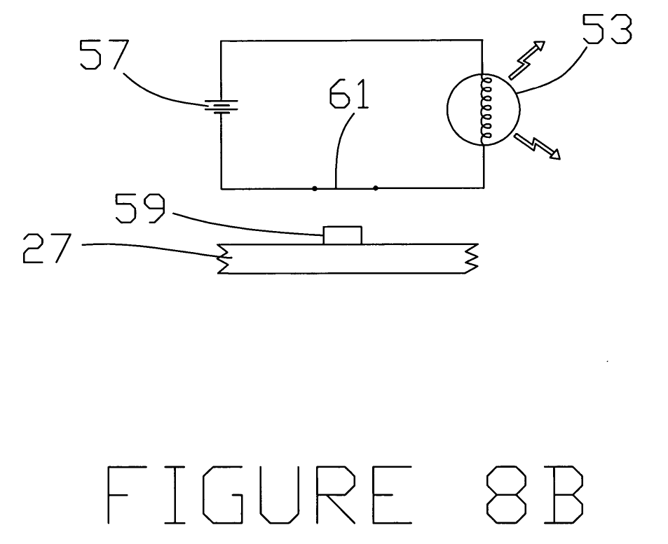

FIGS. 8A and 8B show a magnetic reed switch 61 for activating the indicator device. For ease in understanding this embodiment, only the linkage 27 is shown. A magnetic actuator 59 arranged along linkage 27 pulls the switch 61 closed when the actuator 59 passes near the reed 63. Thus, the magnetic actuator 59 comes near the reed 63 when the latch 17 is disengaged. As shown, the actuator 59 is disposed on one of the piston 19, linkage 27 or latch 37. As the magnetic actuator 59 moves away from the reed 63, the reed switch 61 opens to de-energize the indicator device 54 as shown in FIG. 8A.

It is to be understood that the invention is not limited to the exact construction illustrated and described above. Various changes and modifications may be made without departing from the spirit and the scope of the invention as defined in the following claims.

I claim:

1. A safety system for indicating when a safety device for securing a tailgate is engaged, said safety system including a piston for actuating the safety device and a linkage connected between said piston and the safety device, said safety system further including an electrical circuit comprising:
an indicator device that indicates a position of the safety device;
an electrical power source for supplying power to said indicator device; and,
a switch for indicating whether the safety device for securing the tailgate is disengaged, said switch being closed when the safety device is disengaged to allow electrical power from said electrical power source to flow through the indicator device.

2. The safety system of claim 1 wherein said indicator device is a lamp that is lit when the safety device is disengaged.

3. The safety system of claim 1 wherein said indicator device includes a speaker that emits sound when the safety device is disengaged.

4. The safety system of claim 1 wherein said switch is biased towards a closed position by the piston when the safety device is disengaged and towards an open position when the safety device is engaged.

5. The safety system of claim 1 wherein said switch is biased towards a closed position by the linkage when the safety device is disengaged and towards an open position when the safety device is engaged.

6. The safety system of claim 1 wherein said switch is biased towards a closed position by the safety device when the safety device is disengaged and towards an open position when the safety device is engaged.

7. The safety system of claim 1 wherein said electrical power source is battery system of an automobile.

8. An electrical circuit for indicating whether a safety device that secures a tailgate is engaged, said electrical circuit comprising:
an indicator device that indicates a position of the safety device;
an electrical power source for supplying power to said indicator device; and,
a switch for indicating whether the safety device for securing the tailgate is disengaged, said switch being closed when the safety device is disengaged to allow electrical power from said electrical power source to flow through the indicator device.

9. The safety system of claim 8 wherein said indicator device is a lamp that is lit when the safety device is disengaged.

10. The safety system of claim 8 wherein said indicator device includes a speaker that emits sound when the safety device is disengaged.

11. The safety system of claim 8 wherein said switch is biased towards a closed position by the piston when the safety device is disengaged and towards an open position when the safety device is engaged.

12. The safety system of claim 8 wherein said switch is biased towards a closed position by the linkage when the safety device is disengaged and towards an open position when the safety device is engaged.

13. The safety system of claim 8 wherein said switch is biased towards a closed position by the safety device when the safety device is disengaged and towards an open position when the safety device is engaged.

14. The safety system of claim 8 wherein said electrical power source is battery system of an automobile.

15. A warning system that indicates whether a tailgate is unsecured, said warning system comprising:
a lamp for indicating when a latch that secures a tailgate is disengaged;
a power source for providing electrical energy to the lamp; and,
a switch that energizes said lamp when the latch is disengaged.
